(19) United States
(12) Patent Application Publication
(10) Pub. No.: US 2011/0043323 A1
(43) Pub. Date: Feb. 24, 2011

(54) FAULT MONITORING CIRCUIT, SEMICONDUCTOR INTEGRATED CIRCUIT, AND FAULTY PART LOCATING METHOD

(75) Inventor: Kiyomi HAMASAKO, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/816,800

(22) Filed: Jun. 16, 2010

(30) Foreign Application Priority Data
Aug. 20, 2009 (JP) 2009-191047

(51) Int. Cl. G05B 23/02

(52) U.S. Cl. 340/3.43

(57) ABSTRACT

To provide a fault monitoring circuit capable of reliably transferring fault information to a circuit that maintains the system in the safe state and ensuring the safety as a system, a semiconductor integrated circuit, and a faulty part locating method. A fault monitoring circuit in accordance with an exemplary aspect of the invention obtains a fault signal output from a peripheral monitoring circuit 100 monitoring a peripheral circuit because of a fault in the peripheral circuit through a first path. Further, the fault monitoring circuit includes a fault signal output unit 12 that outputs the obtained fault signal to an external monitoring device. Furthermore, the fault monitoring circuit also includes a control unit 14 that obtains a fault signal output from the peripheral monitoring circuit 100 through a second path different from the first path, and controls an operation of a semiconductor integrated circuit based on the obtained fault signal.

### INCORPORATION BY REFERENCE

This application is based upon and claims the benefit of priority from Japanese patent application No. 2009-191047, filed on Aug. 20, 2009, the disclosure of which is incorporated herein in its entirety by reference.

### BACKGROUND

1. Field of the Invention

The present invention relates to a fault monitoring circuit, a semiconductor integrated circuit, and a faulty part locating method. In particular, the present invention relates to a fault monitoring circuit that controls an operation of a semiconductor integrated circuit, a semiconductor integrated circuit, and a faulty part locating method.

2. Description of Related Art

In the field of EPS (Electronic Power Steering) and ESC (Electronic Stability Control), in which the safety is particularly essential in the field of automobiles, the functional safety (a concept that functions are installed so that the safety of the system and equipment is ensured even when a failure(s) occurs) is important because a malfunction could involve human lives. Therefore, as the international standard (IEC61508) with regard to the functional safety in the automobile field has been issued (ISO26262 for the automobile field is in the process of voting, and will be standardized in 2011), the demand and necessity for designs based on the functional safety concept (high safety and reliability) for microcomputers constituting EPS/ESC systems have been growing. That is, a technique capable of monitoring and determining a fault, and detecting an abnormality in the circuit itself that outputs a fault signal has been required.

Japanese Patent No. 3216996 discloses a technique relating to the redundant-system electronic interlocking devices that are used to control signals and switches in a railroad station premise. A redundant-system electronic interlocking device disclosed in Japanese Patent No. 3216996 is explained hereinafter with reference to FIG. 6. A redundant-system electronic interlocking device includes a control panel 301, coupled systems 302, a reset circuit 303, CPUs 304 and 306, a comparison start/stop circuit 305, latches 307 and 309, a data comparison circuit 308, wait circuits 310 and 311, and a comparison error latch circuit 312. An external device including a general I/F 313, an input/output relay unit 314, and a field device 315 is connected to the redundant-system electronic interlocking device. The control panel 301 is a railroad-station control device or the like in a traffic control system that sends route data to the redundant-system electronic interlocking device in the safety system. The coupled systems 302 couple the control panel 301 with the CPUs 304 and 305. The CPU 304 outputs processing data to the latch circuit 307. The CPU 306 outputs processing data to the latch circuit 309. The data comparison circuit 308 performs a data comparison of processing data of the CPUs 304 and 306 obtained from the latch circuits 307 and 309. As a result of the data comparison, if the processing data do not matches with each other and thus an error occurs, an error signal is output to the comparison error latch circuit 312. The comparison error latch circuit 312 outputs an error signal to the reset circuit 303, and the reset circuit 303 outputs a reset signal generated based on the error signal to the CPUs 304 and 306.

Next, a process flow of a redundant-system electronic interlocking device is explained with reference to FIG. 7. The CPUs 304 and 306 set a write signal and a read signal of processing data of the field device 315 in advance (S51). Next, it is determined whether or not the CPUs 304 and 306 have issued the set write signal and thereby have written data in the field device 315 to control the field device 315 (S52). Next, if the CPUs 304 and 306 have not issued the write signal and thus no writing operation has occurred, the CPUs 304 and 306 perform the control processing of the field device 315 without having any standby state of the processing operation (S53). In this case, the CPUs 304 and 306 output the processing data to the general I/F 313 through the latch circuits 307 and 309 and the data comparison circuit 308. The general I/F 313 outputs the processing data to the field device 315 through the input/output relay unit 314. Next, if the CPUs 304 and 306 have issued a write signal, they output the write signal to the comparison start/stop circuit 305. The comparison start/stop circuit 305 outputs a comparison start signal to the data comparison circuit 308. In this case, the CPUs 304 and 306 process the identical written processing data in the same manner, output processing results and store them in the latch circuits 307 and 309, and cause the data comparison circuit 308 to take them in and to compare the data (S54). During the data comparison operation, the data comparison circuit 308 activates the wait circuits 310 and 311 to hold the processing operation of the CPUs 304 and 306 in a standby state until the data comparison is completed (S55). Next, if the data comparison circuit 308 determines that the comparison result is correct (S56), it is determined that there is no fault and the activated state of the wait circuits 310 and 311 is cancelled. Therefore, the standby state of the CPUs 304 and 306 is cancelled and the process moves to the next processing operation (S57). On the other hand, if the data comparison circuit 308 determines that the processing results of the CPUs 304 and 306 do not match with each other, it is determined that there is a fault(s). Therefore, the comparison error latch circuit 312 stores an error signal, i.e., determination result of the data comparison circuit 308 (S58). Next, when the comparison error latch circuit 312 outputs an error signal to the reset circuit 303, the reset circuit 303 resets the operation by issuing a reset signal to the CPUs 304 and 306.

Japanese Unexamined Patent Application Publication No. 2005-150959 discloses a data transfer system that can prevent the deterioration of transmission characteristics during data transmission, enables the cable route to be easily changed, and has a system redundancy against a fault in the data transfer device and a disconnection of a cable in a system in which high reliability is essential.

### SUMMARY

In the techniques disclosed in Japanese Patent No. 3216996 and Japanese Unexamined Patent Application Publication No. 2005-150959, there is a problem that when a failure occurs in the data comparison circuit, the latch circuit, and the reset circuit, the information about the failure is not transferred to the circuit that maintains the system in the safe state and that the safety as a system thereby cannot be ensured.

A first exemplary aspect of the present invention is a fault monitoring circuit including: a fault signal output unit that obtains a fault signal through a first path and outputs the fault signal to an external monitoring device, the fault signal being output from a peripheral monitoring circuit monitoring a peripheral circuit because of a fault in the peripheral circuit; and a control unit that obtains a fault signal output from the peripheral monitoring circuit through a second path different from the first path, and controls an operation of a semiconductor integrated circuit based on the fault signal.

By using a fault monitoring circuit like this, a fault signal can be notified to the external monitoring device even when a fault occurs in the control unit. Another exemplary aspect of the present invention is a semiconductor integrated circuit including: a peripheral monitoring circuit including a fault detection unit that detects a fault in a peripheral circuit; a first fault signal output unit that obtains a fault signal through a first path and outputs the fault signal to an external monitoring device, the fault signal being output from a peripheral monitoring circuit that has detected a fault in the peripheral circuit; a first control unit that obtains a fault signal through a second path different from the first path and controls an operation of the semiconductor integrated circuit based on the fault signal, the fault signal being output from a peripheral monitoring circuit that has detected a fault in the peripheral circuit; a second fault signal output unit that obtains a fault signal through a third path different from the first and second paths and outputs the fault signal to an external monitoring device, the fault signal being output from a peripheral monitoring circuit that has detected a fault in the peripheral circuit; a second control unit that obtains a fault signal through a fourth path different from the first, second and third paths and controls an operation of the semiconductor integrated circuit based on the fault signal, the fault signal being output from a peripheral monitoring circuit that has detected a fault in the peripheral circuit; and a fault notification unit that, when a fault signal is output from at least one of the first and second fault signal output units, notifies a fault to an external monitoring device.

By using a semiconductor integrated circuit like this, a fault signal can be notified to an external monitoring device even when a fault occurs in the first or second control unit.

Another exemplary aspect of the present invention is a faulty part locating method to locate a faulty part in a circuit including a plurality of peripheral circuits and a plurality of peripheral monitoring circuits monitoring the plurality of peripheral circuits, the faulty part locating method including: outputting a pseudo-fault signal from the peripheral monitoring circuits, the pseudo-fault signal being used to generate a fault in the peripheral circuits in a simulative manner; storing a fault state of the peripheral circuits based on the output pseudo-fault signal; and locating a faulty part in the peripheral circuits, the peripheral monitoring circuits, and wiring lines connecting the peripheral circuits and the peripheral monitoring circuits based on a storage state of the fault state.

By using a faulty part locating method like this, a faulty part in the circuits and wring lines can be located by generating a fault in a simulative manner.

In an exemplary aspect, the present invention can provide a fault monitoring circuit capable of reliably transferring fault information to a circuit that maintains the system in the safe state and ensuring the safety as a system, a semiconductor integrated circuit, and a faulty part locating method.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration diagram of a semiconductor integrated circuit in accordance with a first exemplary embodiment of the present invention;

FIG. 2 is a configuration diagram of an abnormality output circuit and a storage/determination circuit in accordance with a first exemplary embodiment of the present invention;

FIG. 3 is a flowchart of a first exemplary embodiment performed when a fault occurs;

FIG. 4 is a flowchart performed when a self-diagnosis is performed on a semiconductor integrated circuit in accordance with a first exemplary embodiment of the present invention;

FIG. 5 is a flowchart performed when a self-diagnosis is performed on a section from an abnormality monitoring/notification circuit to a system monitoring circuit in accordance with a first exemplary embodiment of the present invention;

FIG. 6 is a configuration diagram of a redundant-system electronic interlocking device disclosed in Japanese Patent No. 3216996; and

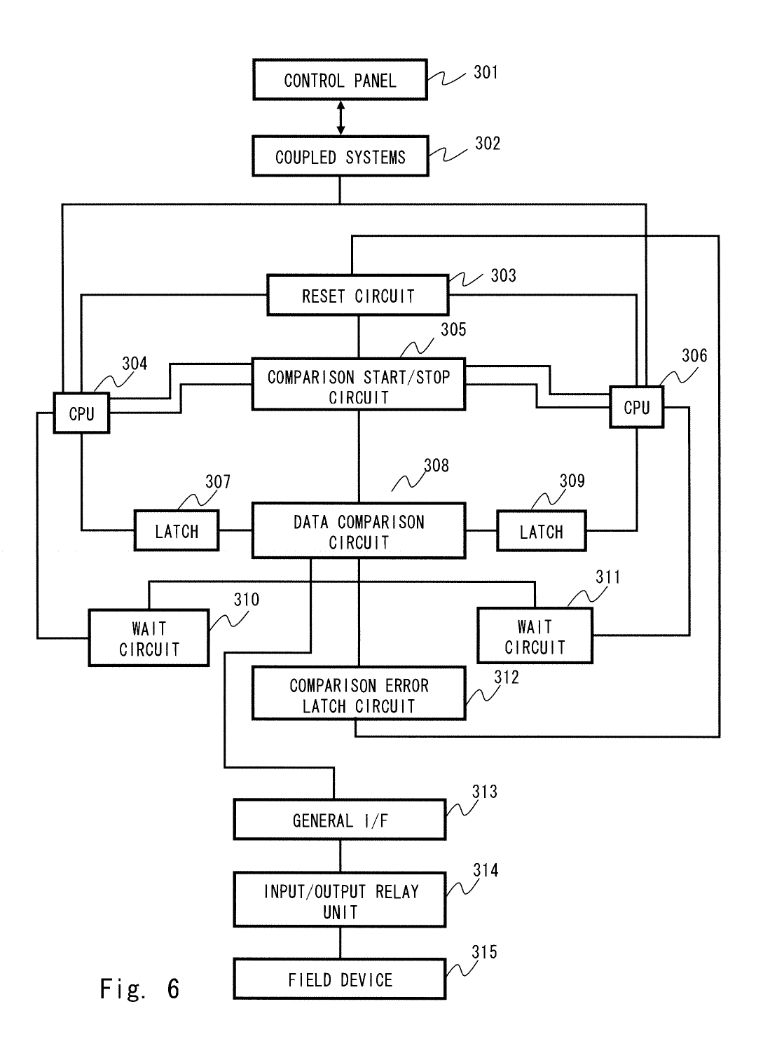

FIG. 7 is a flowchart of a redundant-system electronic interlocking device disclosed in Japanese Patent No. 3216996.

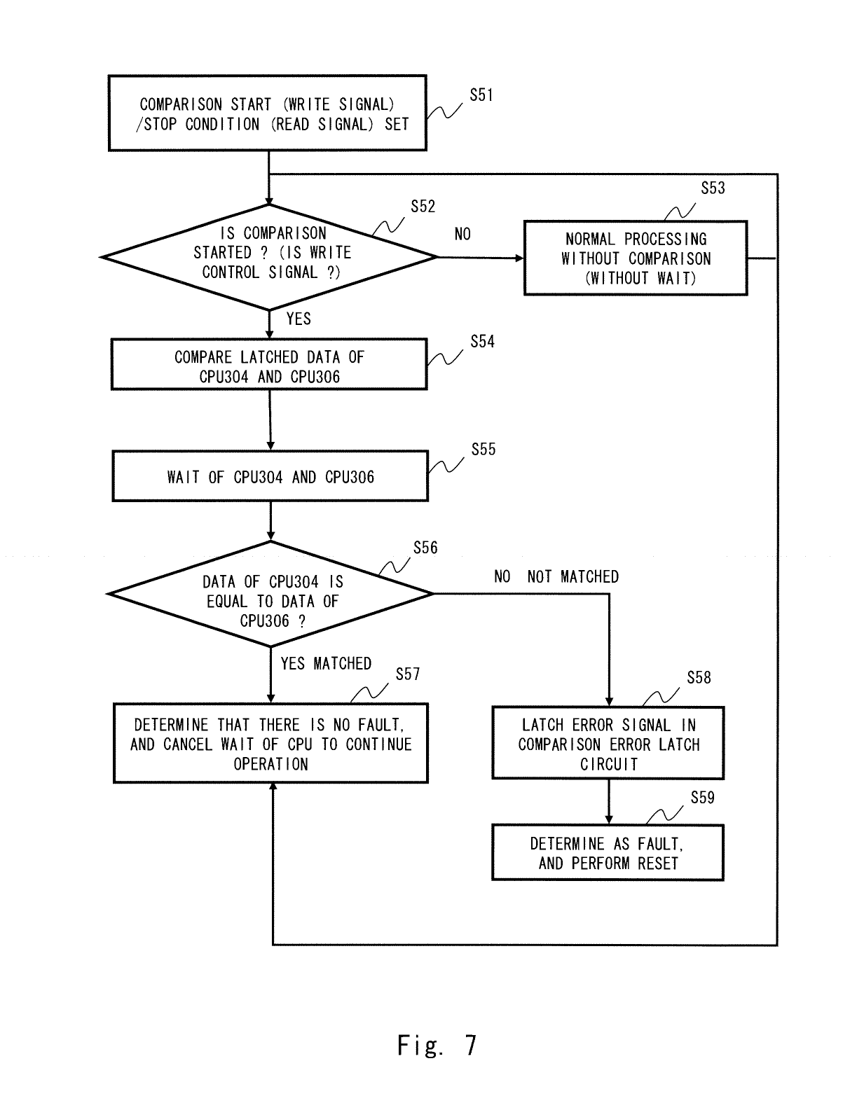

### DETAILED DESCRIPTION OF THE EXEMPLARY EMBODIMENTS

### First Exemplary Embodiment

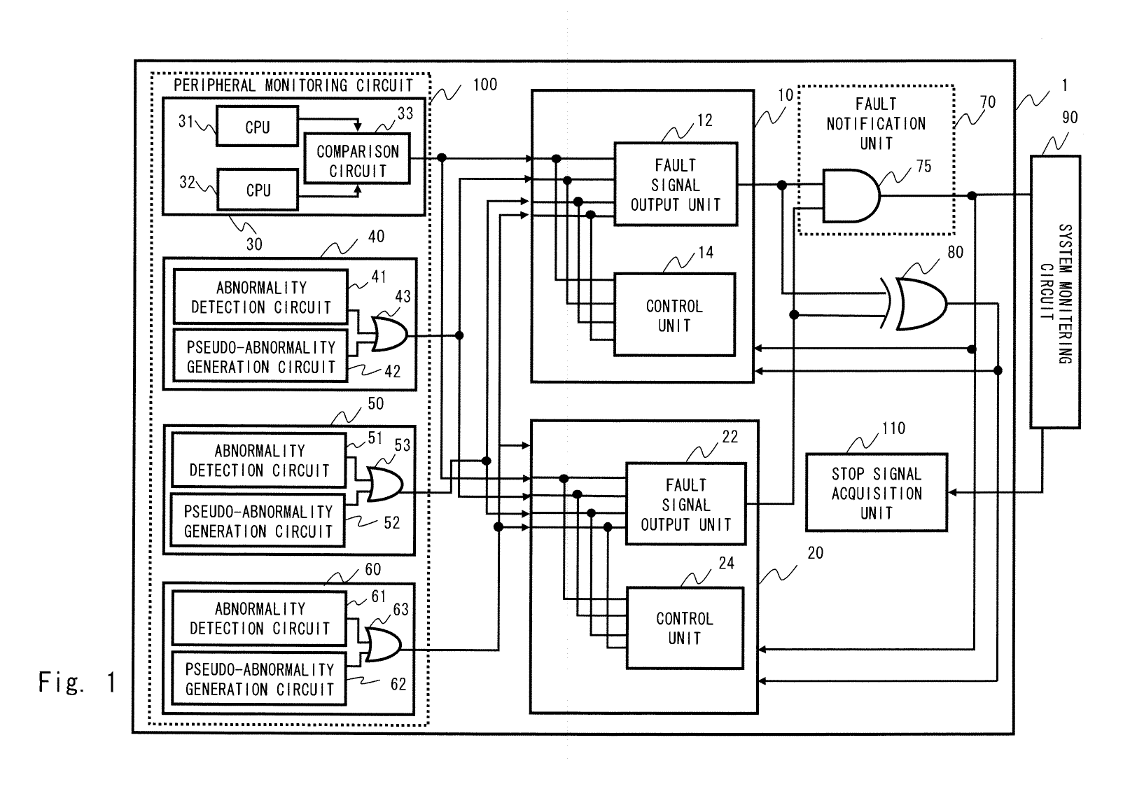

Exemplary embodiments of the present invention are explained hereinafter with reference to the drawings. A configuration example of a semiconductor integrated circuit in accordance with a first exemplary embodiment of the present invention is explained with reference to FIG. 1. A semiconductor integrated circuit 1 includes abnormality monitoring/notification circuits 10 and 20, a CPU subsystem 30, a clock monitor 40, a watch-dog timer 50, a memory ECC circuit 60, a fault notification unit 70, an exclusive-OR circuit 80, and a stop signal acquisition unit 110. The abnormality monitoring/notification circuit 10 includes a fault signal output unit 12 and a control unit 14. Similarly, the abnormality monitoring/notification circuit 20 includes a fault signal output unit 22 and a control unit 24. The CPU subsystem 30 includes CPUs 31 and 32, and a comparison circuit 33. The clock monitor 40 includes an abnormality detection circuit 41, a pseudo-abnormality generation circuit 42, and an OR circuit 43. The watch-dog timer 50 includes an abnormality detection circuit 51, a pseudo-abnormality generation circuit 52, and an OR circuit 53. The memory ECC circuit 60 includes an abnormality detection circuit 61, a pseudo-abnormality generation circuit 62, and an OR circuit 63. The fault notification unit 70 includes an AND circuit 75. Further, the semiconductor integrated circuit 1 is connected to a system monitoring circuit 90 through an AND circuit 75. The CPU subsystem 30, the clock monitor 40, the watch-dog timer 50, and the memory ECC circuit 60 correspond to respective peripheral monitoring circuits 100. Further, the CPUs, which are monitored by the CPU subsystem 30, a clock, which is monitored by the clock monitor 40, a hardware clock, which is monitored by the watch-dog timer 50, and a memory, which is monitored by the memory ECC circuit 60, correspond to respective peripheral circuits.

The semiconductor integrated circuit 1, which is a circuit to monitor a CPU, a clock, and the like, and constitutes an MCU or the like.

The abnormality monitoring/notification circuit 10 and the abnormality monitoring/notification circuit 20 have a twofold redundant connection configuration. Therefore, since they have a similar configuration to each other, only a configuration example of the abnormality monitoring/notification circuit 10 is explained hereinafter. The abnormality monitoring/notification circuit 10 obtains a fault signal used to notify a fault or an abnormal state of the functional blocks, each of which is monitored by a respective one of the CPU subsystem 30, the clock monitor 40, the watch-dog timer 50, and the memory ECC circuit 60. Specifically, the abnormality monitoring/notification circuit 10 obtains a fault signal at the fault signal output unit 12 and the control unit 14. The abnormality monitoring/notification circuit 10 may divide a fault signal output from the CPU subsystem 30 or the like into two signal lines within the abnormality monitoring/notification circuit 10 so that the fault signal is supplied to the fault signal output unit 12 and the control unit 14. Alternatively, the CPU subsystem 30 or the like may output the same fault signal through two physically different paths, and the abnormality monitoring/notification circuit 10 may supply the fault signal to the fault signal output unit 12 and the control unit 14 through the two physically different paths.

The fault signal output unit 12 outputs the obtained fault signal to the system monitoring circuit 90 through the AND circuit 75. Further, the fault signal output unit 12 feeds back an output result of the fault signal to the abnormality monitoring/notification circuit 10 and the abnormality monitoring/notification circuit 20 through the exclusive-OR circuit 80. When a fault signal output from the abnormality monitoring/notification circuit 10 does not match with a fault signal output from the abnormality monitoring/notification circuit 20, it can be presumed that a fault(s) has occurred in one of the abnormality monitoring/notification circuit 10 and the abnormality monitoring/notification circuit 20.

When the fault signal output unit 12 notifies the occurrence of a fault, it sets the fault signal to a low level and outputs the fault signal to the AND circuit 75. The AND circuit 75 obtains fault signals from the fault signal output unit 12 and the fault signal output unit 22. At this point, if the AND circuit 75 obtains a fault signal set at a low-level value from either one or both of the fault signal output unit 12 and the fault signal output unit 22, it presumes that a fault(s) has occurred in the circuit such as the CPU and outputs a signal notifying a fault to the system monitoring circuit 90. Upon reception of the fault notification, the system monitoring circuit 90 outputs a reset control signal, which is used to perform reset control on the circuit such as the CPU, to the stop signal acquisition unit 110 of the semiconductor integrated circuit 1. Upon reception of the reset control signal from the system monitoring circuit 90, the stop signal acquisition unit 110 outputs a reset signal to stop the operation of the circuit in which the fault has occurred or the operation of the semiconductor integrated circuit 1.

Further, when the exclusive-OR circuit 80 obtains identical values from the fault signal output unit 12 and the fault signal output unit 22, it outputs a signal set at a low-level value, which indicates that the operations of the abnormality monitoring/notification circuit 10 and the abnormality monitoring/notification circuit 20, and the signal outputs from the CPU subsystem 30 and the like are normal, to the abnormality monitoring/notification circuit 10 and the abnormality monitoring/notification circuit 20. When the exclusive-OR circuit 80 obtains different values from the fault signal output unit 12 and the fault signal output unit 22, it outputs a signal set at a high-level value, which indicates that the operation of the abnormality monitoring/notification circuit 10 or the abnormality monitoring/notification circuit 20, or the signal output from the CPU subsystem 30 or the like is abnormal, to the abnormality monitoring/notification circuit 10 and the abnormality monitoring/notification circuit 20.

The control unit 14 generates a reset signal used to stop the operation of the CPU, the clock, and the like based on a fault signal that is obtained through a path different from that of the fault signal output unit 12, and outputs the reset signal to the circuit(s) constituting the CPU, the clock, and the like. The circuit that has received the reset signal stops its operation.

The CPU subsystem 30 includes the CPUs 31 and 32 having a redundant configuration, and the comparison circuit 33. The comparison circuit 33 obtains processing data of the CPUs 31 and 32 and determines whether the obtained data match with each other or not. When the obtained data do not match with each other, the comparison circuit 33 outputs a fault signal used to notify the fault of the CPU to the abnormality monitoring/notification circuit 10 and the abnormality monitoring/notification circuit 20. The comparison circuit 33 may output a fault signal to the fault signal output unit 12 and the control unit 14 of the abnormality monitoring/notification circuit 10 through physically different paths, and/or may output a fault signal through the same path at least to the abnormality monitoring/notification circuit 10. The comparison circuit 33 also outputs a fault signal to the abnormality monitoring/notification circuit 20.

The clock monitor 40 includes an abnormality detection circuit 41 that detects a fault of an abnormal state of a clock circuit (not shown), a pseudo-abnormality generation circuit 42 that generates a fault of the clock circuit in a simulative manner or a pseudo manner, and an OR circuit 43. When the OR circuit 43 obtains a fault signal from either one or both of the abnormality detection circuit 41 and the pseudo-abnormality generation circuit 42, it outputs a fault signal to the abnormality monitoring/notification circuit 10 and the abnormality monitoring/notification circuit 20. Similarly to the comparison circuit 33 of the CPU subsystem 30, the path through which the clock monitor 40 outputs a fault signal may be composed of physically different paths or the physically same path. Each of the watch-dog timer 50 and the memory ECC circuit 60 outputs a fault signal in a similar manner to that of the clock monitor 40, and therefore their explanations are omitted.

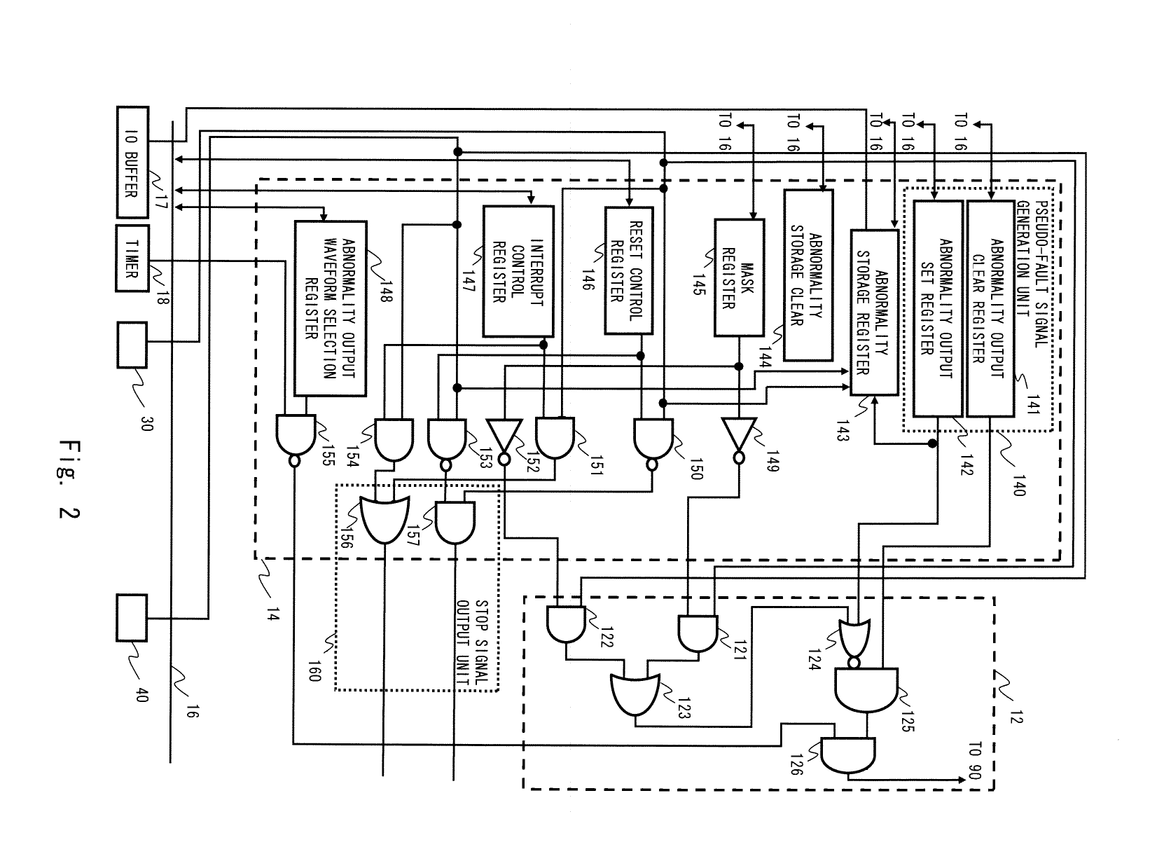

Next, a configuration example of the fault signal output unit 12 and the control unit 14 of the abnormality monitoring/notification circuit 10 in accordance with this first exemplary embodiment of the present invention is explained hereinafter with reference to FIG. 2. Note that the configuration of the abnormality monitoring/notification circuit 20 is similar to that of the abnormality monitoring/notification circuit 10.

The control unit 14 includes an abnormality output clear register 141, an abnormality output set register 142, an abnormality storage register 143, an abnormality storage clear register 144, a mask register 145, a reset control register 146, an interrupt control register 147, an abnormality output waveform selection register 148, inverter circuits 149 and 152, NAND circuits 150 and 153, AND circuits 151 and 154, a NAND circuit 155, an OR circuit 156, and an AND circuit 157. Note that the abnormality output clear register 141 and the abnormality output set register 142 constitute a pseudo-fault signal generation unit 140. Further, the OR circuit 156 and the AND circuit 157 constitute a stop signal output unit 160 in the control unit 14. Furthermore, the abnormality storage register 143 constitutes a fault storage unit.

When the mask register 145 is notified of the occurrence of a fault from the peripheral monitoring circuit such as the CPU subsystem 30 and the clock monitor 40 through a data bus 16, the mask register 145 controls whether the fault information should be notified to the system monitoring circuit 90 or not. For example, in operations in which the fault information is to be notified to the system monitoring circuit 90 when a significant fault occurs, whereas the fault information is not to be notified to the system monitoring circuit 90 when the level of the significance of the fault is relatively low, the mask register 145 controls whether the occurrence of a fault should be notified to the system monitoring circuit 90 or not. Whether the occurrence of a fault should be notified or not is determined in advance according to the location of the occurrence of the fault or the level of the fault or the like. When the mask register 145 does not notify the occurrence of a fault to the system monitoring circuit 90, i.e., when the mask register 145 masks the fault signal, it outputs a high-level value to the inverter circuits 149 and 152. On the other hand, when the mask register 145 notifies the occurrence of a fault to the system monitoring circuit 90, it outputs a low-level value to the inverter circuits 149 and 152. The inverter circuits 149 and 152 invert the obtained signals and output the inverted signals to the AND circuits 121 and 122, respectively, of the fault signal output unit 12.

When the reset control register 146 is notified of the occurrence of a fault in the CPU subsystem 30 or the like through the data bus 16, the reset control register 146 controls whether the operation of the respective circuits such as the CPU in which the fault has occurred should be stopped or not because of that fault. For example, if the location of the occurrence of the fault is in the CPU having important functions, the operation may be stopped, whereas if it is in other circuits whose level of the significance is relatively low, the operation may not be stopped. Alternatively, whether the operation should be stopped or not may be determined based on the level of the fault.

When the operation of the circuit is to be stopped due to the occurrence of a fault, the reset control register 146 outputs a signal set at a high level to the NAND circuits 150 and 153. When the operation of the circuit is not to be stopped due to the occurrence of a fault, the reset control register 146 outputs a signal set at a low level to the NAND circuits 150 and 153.

The NAND circuits 150 and 153 obtain a signal relating to the reset control from the reset control register 146, and also obtain a fault signal notifying the occurrence of a fault from the CPU subsystem 30 or the clock monitor 40 or the like. When the NAND circuits 150 and 153 obtain a signal set at high level from the reset control register 146 and a fault signal set at a high-level value notifying the occurrence of a fault from the CPU subsystem 30 or the clock monitor 40 or the like, they output a signal set at a low-level value to the AND circuit 157. When the AND circuit 157 obtains a signal set at a low level from either one or both of the NAND circuits 150 and 153, it outputs a reset signal set at a low level to stop the operation of the relevant circuit(s). The circuit(s) whose operation should be stopped may be the circuit in which the fault has occurred, or a plurality of circuits relating to the circuit in which the fault has occurred.

When a fault occurs in the CPU subsystem 30 or the clock monitor 40 or the like, the interrupt control register 147 controls whether or not the process that is currently being processed in the CPU should be interrupted so that another process different from the current process is processed. When the interrupt control register 147 performs interrupt processing, it outputs a signal set at a high-level value to the AND circuits 151 and 154. The AND circuits 151 and 154 obtain a signal relating to the interrupt processing from the interrupt control register 147, and also obtain a fault signal from the CPU subsystem 30 or the clock monitor 40 or the like. When the AND circuits 151 and 154 obtain a signal set at a high level from both the interrupt control register 147 and the CPU subsystem 30 or the clock monitor 40 or the like, they output a signal set at a high level to the OR circuit 156. When the OR circuit 156 obtains a signal set at a high level from either one or both of the AND circuits 151 and 154, it outputs an interrupt signal used to perform interrupt processing.

The abnormality output waveform selection register 148 performs output control of a pulse signal output from a timer 18. Specifically, when no fault occurs in the peripheral circuit such as the CPU subsystem 30 and the clock monitor 40, it outputs the pulse signal output from the timer 18 to the fault signal output unit 12. The fault signal output unit 12 notifies that the circuit is normal by outputting the obtained pulse signal to the system monitoring circuit 90. When a fault has occurred in the CPU subsystem 30 or the clock monitor 40 or the like, or when a fault has occurred in the timer 18, it outputs a fixed value to the fault signal output unit 12. For example, when no fault has occurred in the CPU subsystem 30 or the clock monitor 40 or the like, the abnormality output waveform selection register 148 outputs a signal set at a high-level value to the NAND circuit 155. The timer 18 outputs a pulse signal to the NAND circuit 155. As a result, the NAND circuit 155 outputs a pulse signal to the AND circuit 126 of the fault signal output unit 12.

In contrast to this, when the occurrence of a fault in the CPU subsystem 30 or the clock monitor 40 or the like is notified through the data bus 16, the abnormality output waveform selection register 148 outputs a signal set at a low-level value to the NAND circuit 155. In this case, the NAND circuit 155 outputs a signal set at a high-level value, which is obtained by inverting the signal set at a low-level value, to the AND circuit 126 of the fault signal output unit 12 irrespective of the signal obtained from the timer 18. Further, if a fault has occurred in the timer 18, the timer 18 cannot outputs a pulse signal and thus outputs a signal set at a high-level value or a low-level value to the NAND circuit 155. In this case, since the abnormality output waveform selection register 148 is not notified of any fault of the CPU subsystem 30 or the clock monitor 40 or the like, it outputs a signal set at a high-level value to the NAND circuit 155. Therefore, the NAND circuit 155 outputs a signal set at a high-level value or a low-level value to the AND circuit 126 of the fault signal output unit 12.

The abnormality output set register 142 generates and outputs a pseudo-fault signal that is used to generate a fault in the peripheral circuits in a simulative manner. The pseudo-fault signal is used to verify the normal circuit operation when no real fault exists in the peripheral circuits. The presence/absence of the occurrence of a fault in the peripheral circuits is determined based on information notified through the data bus 16. The pseudo-fault signal indicates that a fault has occurred in a simulative manner when it is set to a high-level value. The abnormality output set register 142 outputs the generated pseudo-fault signal to the NOR circuit 124 of the fault signal output unit 12. Further, the abnormality output clear register 141 generates and outputs a signal used to clear the pseudo-fault signal output from the abnormality output set register 142. The abnormality output clear register 141 sets a different value from the value set in the abnormality output set register 142 and outputs the set value to the AND circuit 125.

When a fault has occurred in the peripheral circuits, the abnormality storage register 143 retains the state of the fault occurrence. Specifically, the abnormality storage register 143 obtains a fault signal notified from the CPU subsystem 30 or the clock monitor 40 or the like, and retains the fault state. The abnormality storage register 143 may obtain the fault signal directly from the CPU subsystem 30 or the clock monitor 40 or the like, or may obtain it through the data bus 16. Further, when the abnormality output set register 142 generates a fault of the peripheral circuits in a simulative manner, the abnormality storage register 143 obtains the pseudo-fault signal and retains the fault state.

The abnormality storage clear register 144 outputs a clear signal to the abnormality storage clear register 144 when fault information retained in the abnormality storage register 143 is to be cleared. For example, the abnormality storage clear register 144 may clear the fault information retained in the abnormality storage register 143 when a recovery from the fault is notified through the data bus 16.

Next, a configuration example of the fault signal output unit 12 is explained hereinafter. The fault signal output unit 12 includes AND circuits 121 and 122, an OR circuit 123, a NOR circuit 124, and AND circuits 125 and 126. The fault signal output unit 12 is composed of a combination circuit(s) alone, of which the output is uniquely determined.

The AND circuit 121 obtains a signal indicating whether a fault should be notified from the mask register 145 to the system monitoring circuit 90, and also obtains a fault signal from the CPU subsystem 30. Note that the fault signal obtained from the CPU subsystem 30 is supplied to the fault signal output unit 12 through a different path from the path through which the fault signal is supplied to the control unit 14. That is, the fault signal output unit 12 does not obtain the fault signal through the control unit 14, but does obtain the fault signal directly from the CPU subsystem 30.

The AND circuit 121 is notified of the occurrence of a fault from the CPU subsystem 30 by a fault signal set at a high-level value. Further, when the notification of the fault to the system monitoring circuit 90 is permitted by the mask register 145 through a signal set at a high-level value obtained through the inverter circuit 149, the AND circuit 121 outputs a signal set at a high-level value to the OR circuit 123. The AND circuit 122, which obtains a fault signal from the clock monitor 40, operates in a similar manner to that of the AND circuit 121, and outputs a signal set at a high-level value of a low-level value to the OR circuit 123. Further, an AND circuit corresponding to the AND circuit 121 or 122 is provided for each of the peripheral monitoring circuits 100. That is, there are other AND circuits each of which obtains a signal from a respective one of the watch-dog timer 50 and the memory ECC circuit 60 (not shown).

When the OR circuit 123 obtains a signal set at a high-level value from at least one of the AND circuits 121 and 122, it outputs a signal set at a high-level value to the NOR circuit 124. That is, when the OR circuit 123 receives a fault signal from at least one of the AND circuits 121 and 122, it outputs a signal set at a high-level value to the NOR circuit 124. When the NOR circuit 124 obtains a signal set at a high-level value from the OR circuit 123, it outputs a signal set at a low-level value, which is obtained by inverting the signal set at a high-level value, to the AND circuit 125.

Upon reception of the signal set at a low-level value from the NOR circuit 124, the NAND circuit 125 outputs a signal set at a low-level value to the AND circuit 126 irrespective of the value obtained from the abnormality output clear register 141. Upon reception of the signal set at a low-level value from the AND circuit 125, the AND circuit 126 outputs a signal set at a low-level value to the system monitoring circuit 90 irrespective of the signal output from the timer 18 through the NAND circuit 155. When a signal set at a low-level value is output from the AND circuit 126, it indicates that a fault(s) has occurred.

Further, when no fault occurs in the peripheral circuits and thereby no fault signal set at a high-level value is notified from the CPU subsystem 30 or the clock monitor 40 or the like, the AND circuits 121 and 122 output a signal set at a low-level value to the OR circuit 123. Further, the OR circuit 123 also outputs a signal set at a low-level value to the NOR circuit 124. At this point, when the abnormality output set register 142 is not generating a pseudo-fault signal and is thereby outputting a signal set at a low-level value, the NOR circuit 124 outputs a signal set at a high-level value to the AND circuit 125. The AND circuit 125 obtains the signal set at a high-level value from the NOR circuit 124, and also obtains a signal set at a high-level value from the abnormality output clear register 141. Therefore, it outputs a signal set at a high-level value to the AND circuit 126. Note that when no fault occurs in the peripheral circuits, the AND circuit 126 obtains a pulse signal from the NAND circuit 155. Therefore, the AND circuit 126 outputs a pulse signal indicating that no fault occurs to the system monitoring circuit 90.

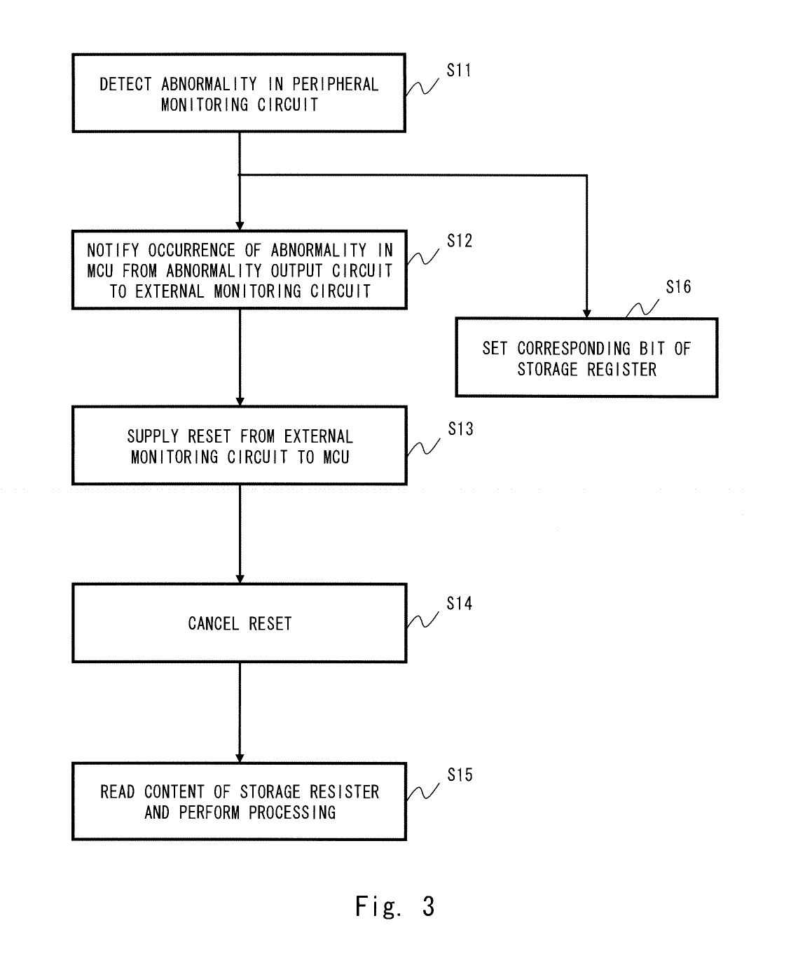

Next, a process flow in accordance with this first exemplary embodiment performed at the time of a fault occurrence is explained with reference to FIG. 3. Firstly, the peripheral monitoring circuits 100 such as the CPU subsystem 30 and the clock monitor 40 detect a fault (S11).

Next, the fault signal output unit 12 and the fault signal output unit 22, which are notified of the occurrence of the fault from the peripheral monitoring circuits, notify the occurrence of the abnormality in the MCU composed of the CPU, the clock, and the like to the system monitoring circuit 90 (S12). Further, in addition to notifying the occurrence of the abnormality to the system monitoring circuit 90, they store the fault state in the abnormality storage register 143 of the control unit 14 (S16). That is, the abnormality storage register 143 sets a value in a corresponding bit used to record the fault state.

Next, the system monitoring circuit 90 outputs a reset signal to the stop signal acquisition unit 110 of the semiconductor integrated circuit 1 (S13). In this way, the stop signal acquisition unit 110 resets the circuit such as the CPU and the clock in which the fault has occurred to the initial state in order to stop its operation. Note that when the circuit such as the CPU and the clock is provided in the semiconductor integrated circuit 1, the operation of the semiconductor integrated circuit 1 may be stopped. Further, the operation of the CPU, the clock, and the like may be stopped based on a reset signal output from the control unit 14 and/or the control unit 24, which are notified of the occurrence of the fault.

Then, when the CPU is notified that the reset state has been cancelled from the system monitoring circuit 90 (S14), the CPU reads the content of each register of the control unit 14 or the control unit 24 through the data bus 16 and continues the operation (S15).

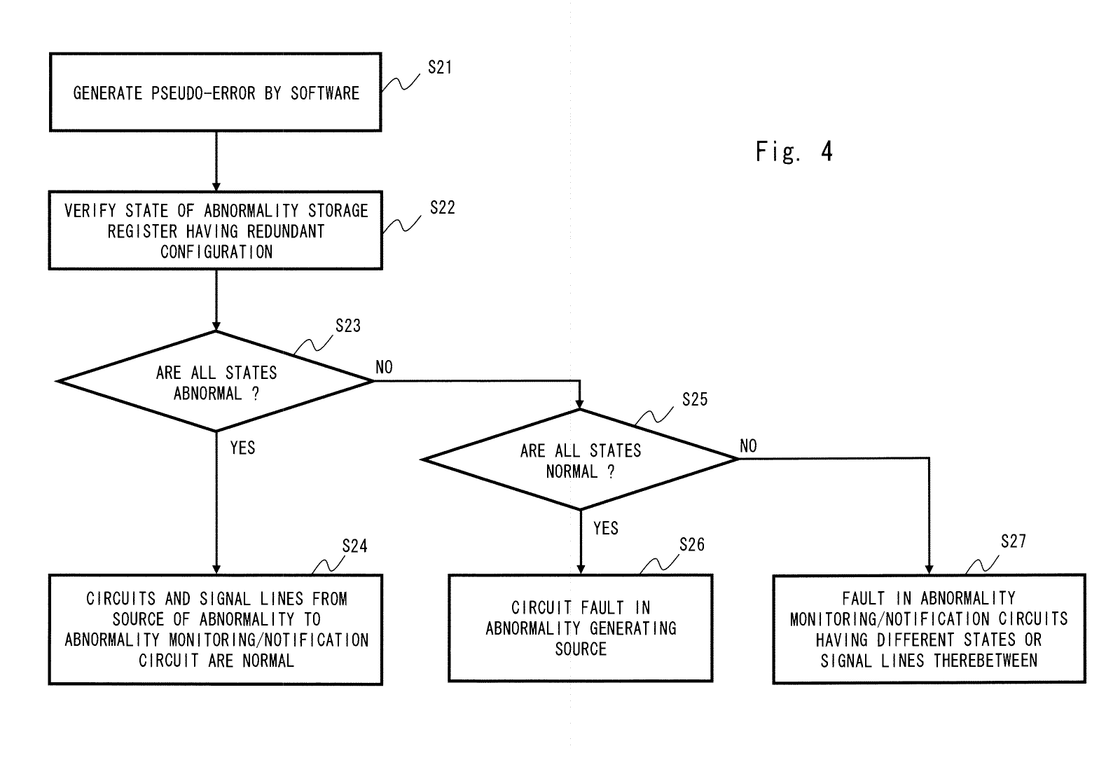

Next, a process flow of a self-diagnosis of the semiconductor integrated circuit 1 in accordance with this first exemplary embodiment of the present invention is explained with reference to FIG. 4. Firstly, the clock monitor 40, the watch-dog timer 50, or the memory ECC circuit 60 generates a pseudo-abnormality or a pseudo-fault by using the pseudo-fault generation circuit (S21).

Next, the computer, which is performing a self-diagnostic test, verifies the state of the abnormality storage register of the control unit 14 and the control unit 24 (S22).

Next, the computer, which is performing a self-diagnostic test, verifies whether or not an abnormal state is set in the abnormality storage register of the control unit 14 and the control unit 24 (S23). If an abnormal state is set in the abnormality storage registers of both the control unit 14 and the control unit 24, i.e., in all the abnormality storage registers, it can be determined that the circuits and signal lines from the clock monitor 40, the watch-dog timer 50, or the memory ECC circuit 60, which is the source of the abnormality, to the abnormality monitoring/notification circuit 10 and the abnormality monitoring/notification circuit 20 are normal (S24).

If the abnormal state is not set in the all the abnormality storage registers, the computer, which is performing a self-diagnostic test, verifies whether or not a normal state is set in the all the abnormality storage registers (S25). If an normal state is set in all the abnormality storage registers, it can be determined that the fault originates in the clock monitor 40, the watch-dog timer 50, or the memory ECC circuit 60, which is the source of the abnormality, because the fault signal is not reflected on the abnormality storage registers of the control unit 14 and the control unit 24 (S26).

When an abnormal state is set in the abnormality storage register of one of the control units 14 and 24 and a normal state is set in the abnormality storage register of the other control unit, it can be determined that the fault originates in the storage/determination circuit having the abnormality storage register in which the normal state is set, or in the signal lines from the clock monitor 40, the watch-dog timer 50, or the memory ECC circuit 60 to that storage/determination circuit (S27).

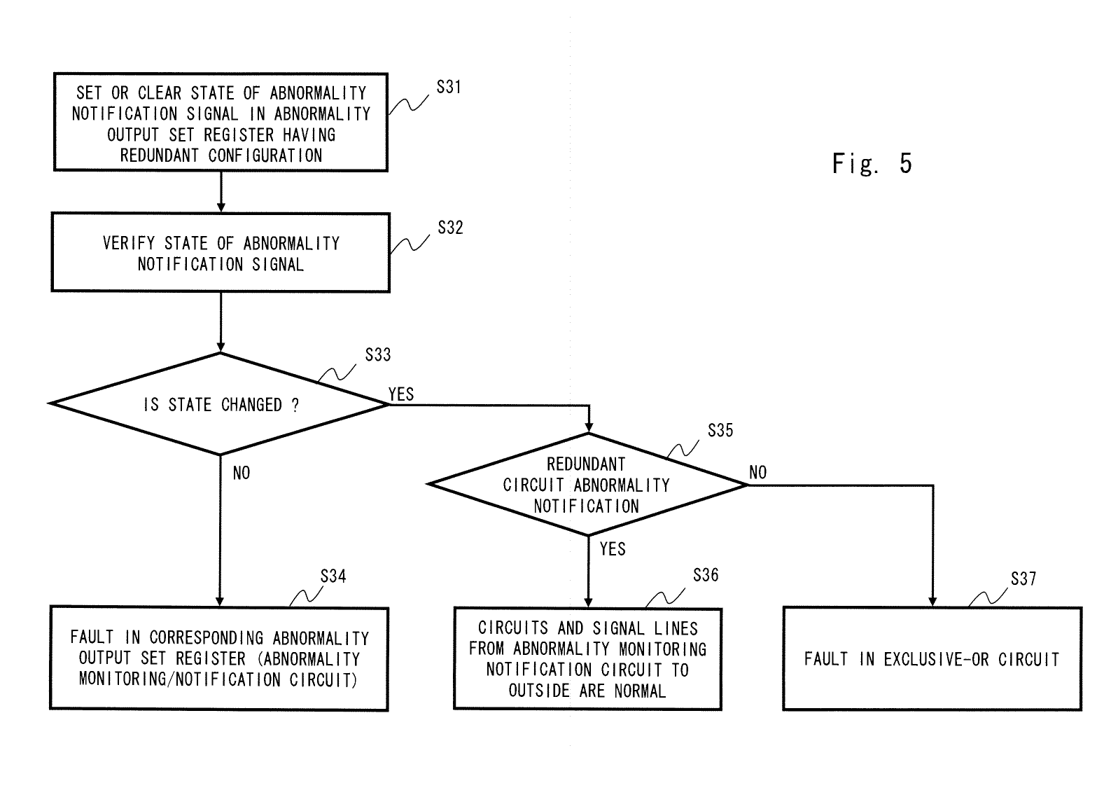

Next, a process flow of a self-diagnosis of the portion from the abnormality monitoring/notification circuit 10 or the abnormality monitoring/notification circuit 20 to the system monitoring circuit 90 in accordance with this first exemplary embodiment of the present invention is explained with reference to FIG. 5.

Firstly, the abnormality output set register of one of the abnormality monitoring/notification circuit 10 and the abnormality monitoring/notification circuit 20 changes the state of an abnormality notification signal to a set state or a clear state (S31). Next, the state of the abnormality notification signal that is output to the system monitoring circuit 90 is verified (S32). The verification of the state of the abnormality notification signal is performed by, for example, a computer.

At this point, it is verified whether or not the state of the abnormality notification signal has changed from an abnormality notification state to a normal state or from a normal state to an abnormality notification state (S33). If the state of the abnormality notification signal to the system monitoring circuit 90 has not changed, it can be determined that the fault originates in the abnormality output set register that has generated the pseudo-abnormality signal (S34).

Next, if the state of the abnormality notification signal to the system monitoring circuit 90 has changed, the output state of the exclusive-OR circuit 80 is verified (S35). The exclusive-OR circuit 80 outputs a signal set at a high-level value when signals output from the fault signal output unit 12 and the fault signal output unit 22 are different from each other. That is, when a signal set at a high-level value is output, it indicates that the occurrence of a fault in the circuit of either one of the abnormality monitoring/notification circuit 10 and the abnormality monitoring/notification circuit 20 has been detected. At this moment, the pseudo-abnormality signal is generated by the abnormality output set register of one of the control unit 14 and the control unit 24. Therefore, if the exclusive-OR circuit 80 is normal, it detects the occurrence of the fault. Accordingly, if the exclusive-OR circuit 80 outputs a signal set at a high-level value, it means that the fault is properly detected. Therefore, it can be determined that the circuits and signal lines from the abnormality monitoring/notification circuit 10 and the abnormality monitoring/notification circuit 20 to the system monitoring circuit 90 are normal (S36).

If the exclusive-OR circuit 80 outputs a signal set at a low-level value, it means the fault is not properly detected. Therefore, it can be determined that a fault has occurred in the exclusive-OR circuit 80 (S37).

As has been explained above, in the semiconductor integrated circuit in accordance with this first exemplary embodiment of the present invention, the path from the circuit that has detected a fault to the abnormality output circuit that notifies the abnormal state to the system monitoring circuit, which is an external device, is different from the path through which the fault is notified from the circuit that has detected the fault to the storage/determination circuit that performs reset control and the like because of the occurrence of the fault in the circuit. In this way, even if a fault occurs in the storage/determination circuit, the abnormal state of the circuit can be notified to the system monitoring circuit. Therefore, a reset signal can be notified from the system monitoring circuit to the semiconductor integrated circuit, and therefore the operation of the circuit in which the fault has occurred can be stopped. Further, even if a fault occurs in the abnormality output circuit, the fault is properly notified from the circuit that has detected the fault to the storage/determination circuit. In this way, the operation of the circuit in which the fault has occurred can be stopped. Further, by performing self-diagnosis processing using a pseudo-fault signal output from the peripheral monitoring circuit or the abnormality monitoring/notification circuit, the faulty part can be located.

Note that the present invention is not limited to the above-described exemplary embodiments, and various modifications can be made without departing from the scope and spirit of the present invention.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A fault monitoring circuit comprising:
a fault signal output unit that obtains a fault signal through a first path and outputs the fault signal to an external monitoring device, the fault signal being output from a peripheral monitoring circuit monitoring a peripheral circuit because of a fault in the peripheral circuit; and
a control unit that obtains a fault signal output from the peripheral monitoring circuit through a second path different from the first path, and controls an operation of a semiconductor integrated circuit based on the fault signal.

2. The fault monitoring circuit according to claim 1, further comprising a stop signal acquisition unit that obtains a stop signal output from the external monitoring device in response to a fault signal output from the fault signal output unit,
wherein an operation of a peripheral circuit in which the fault has occurred is stopped by a stop signal obtained by the stop signal acquisition unit.

3. The fault monitoring circuit according to claim 1, further comprising a pseudo-fault signal generation unit that generates a first pseudo-fault signal used to generate a fault in the peripheral circuit in a simulative manner, and outputs the first pseudo-fault signal to the fault signal output unit,
wherein the fault signal output unit outputs a fault signal to the external monitoring device based on the first pseudo-fault signal.

4. The fault monitoring circuit according to claim 1, further comprising a mask unit that determines whether or not a fault signal obtained by the fault signal output unit is output to the external monitoring device.

5. The fault monitoring circuit according to claim 1, wherein the control unit comprises a stop signal output unit that generates a stop signal used to stop an operation of a peripheral circuit in which the fault has occurred based on the fault signal, and output the stop signal.

6. The fault monitoring circuit according to claim 1, further comprising a fault storage unit that stores a fault state of the peripheral circuit specified based on a fault signal obtained by the control unit.

7. A semiconductor integrated circuit comprising:
a peripheral monitoring circuit comprising a fault detection unit that detects a fault in a peripheral circuit;
a first fault signal output unit that obtains a fault signal through a first path and outputs the fault signal to an external monitoring device, the fault signal being output from a peripheral monitoring circuit that has detected a fault in the peripheral circuit;
a first control unit that obtains a fault signal through a second path different from the first path and controls an operation of the semiconductor integrated circuit based on the fault signal, the fault signal being output from a peripheral monitoring circuit that has detected a fault in the peripheral circuit;
a second fault signal output unit that obtains a fault signal through a third path different from the first and second paths and outputs the fault signal to an external monitoring device, the fault signal being output from a peripheral monitoring circuit that has detected a fault in the peripheral circuit;
a second control unit that obtains a fault signal through a fourth path different from the first, second and third paths and controls an operation of the semiconductor integrated circuit based on the fault signal, the fault signal being output from a peripheral monitoring circuit that has detected a fault in the peripheral circuit; and
a fault notification unit that, when a fault signal is output from at least one of the first and second fault signal output units, notifies a fault to an external monitoring device.

8. The semiconductor integrated circuit according to claim 7, further comprising a fault storage unit that stores a fault state of the peripheral circuit specified based on a fault signal obtained by the first and second control units.

9. A faulty part locating method to locate a faulty part in a circuit comprising a plurality of peripheral circuits and a plurality of peripheral monitoring circuits monitoring the plurality of peripheral circuits, the faulty part locating method comprising:
outputting a pseudo-fault signal from the peripheral monitoring circuits, the pseudo-fault signal being used to generate a fault in the peripheral circuits in a simulative manner;
storing a fault state of the peripheral circuits based on the output pseudo-fault signal; and
locating a faulty part in the peripheral circuits, the peripheral monitoring circuits, and wiring lines connecting the peripheral circuits and the peripheral monitoring circuits based on a storage state of the fault state.
